(19) United States
(12) Patent Application Publication
(10) Pub. No.: US 2016/0080574 A1
(43) Pub. Date: Mar. 17, 2016

(54) FACILITATED SELECTED SPECIALIST COMMUNICATION

(71) Applicant: Prolifiq Software Inc., Beaverton, OR (US)

(72) Inventors: Anh Huynh, Tigard, OR (US); Hemingway Huynh, Salem, OR (US); Jeffrey Michael Farnsworth, Portland, OR (US); Isabella Wong, Bellevue, WA (US)

(21) Appl. No.: 14/850,852

(22) Filed: Sep. 10, 2015

Related U.S. Application Data
(60) Provisional application No. 62/049,934, filed on Sep. 12, 2014.

(51) Int. Cl. H04M 3/523; H04N 7/14; H04M 3/56

(52) U.S. Cl. CPC H04M 3/5233; H04M 3/563; H04N 7/147

(57) ABSTRACT

Embodiments are described herein directed to a selected specialist communication system (“SSC”) to facilitate communication with a specialist. The SSC may be utilized where a representative may wish to facilitate communication between a provider and a specialist. The SSC may select from specialists based on one or more factors. Selection of specialists may prevent repeated contacts between particular specialists and providers to reduce undue influence. The SSC may facilitate establishment of a video and/or audio connection between the provider and the specialist. The communication may utilize a device of the representative. The SSC may request disclosures from providers and/or representatives. Other embodiments may be described and/or claimed.

### CROSS-REFERENCE TO RELATED APPLICATION

This application claims the benefit of U.S. Provisional Application No. 62/049,934, filed Sep. 12, 2014, and entitled “FACILITATED SELECTED SPECIALIST COMMUNICATION”, which is incorporated herein by reference in its entirety.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Representatives in certain industries (such as pharmaceutical and medical device manufacturing), frequently interface with providers of services (such as health care providers) in order to educate and answer questions about the products or services they represent. However, at times, these providers may require information that is not available or unknown to the representatives. For example, if a physician requests information about an usage of a drug that has not been officially vetted (e.g., “off label” usage of the drug) the representative may find him or herself unable to respond to the physicians particular questions. This inability may be due to the representative's lack of knowledge and/or due to legal or professional regulations preventing the representative for providing such information.

In such situations, the representative may wish to facilitate communication between the provider and a third-party specialist (such as a pharmaceutical specialist or device specialist) that may be able to provide additional information to the provider. However, due to regulations, it may be difficult or impossible for the representative to arrange for such a communication in advance of the provider's request. In such cases, it is difficult for providers to obtain the information they need in a timely manner.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figs. of the accompanying drawings.

FIG. 1 illustrates an arrangement for facilitating selected specialist communication, in accordance with various embodiments.

FIG. 2 illustrates an example process for presenting dynamic directory information to a user, in accordance with various embodiments.

FIG. 3 illustrates an example process for setting up information about specialists and/or providers, in accordance with various embodiments.

FIG. 4 illustrates an example process for initiating communication between a provider and a specialist, in accordance with various embodiments.

FIG. 5 illustrates an example process for facilitating communication between the provider and the specialist, in accordance with various embodiments.

FIGS. 6-11 illustrate example interfaces provided by the one or more communication modules of a representative device, in accordance with various embodiments.

FIGS. 12-17 illustrate example interfaces provided by the one or more communication modules of a specialist device, in accordance with various embodiments.

FIG. 18 illustrates an example computing environment suitable for practicing various aspects of the present disclosure in accordance with various embodiments.

FIG. 19 illustrates an example storage medium with instructions configured to enable an apparatus to practice various aspects of the present disclosure in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

Embodiments described herein are directed to, for example, methods, apparatuses, systems, and computer-readable media for facilitating communication with selected specialists. In various embodiments, a selected specialist communication system (“SSC”) may be configured to facilitate communication with a specialist. In particular embodiments, the SSC may be utilized in environments where a representative may wish to facilitate communication between a provider (such as a health care provider) or other knowledge worker, and a specialist with particular training or information in an area in which the provider wishes to obtain knowledge. For example, in various embodiments a pharmaceutical representative may, when asked by a physician about off-label usage of a particular drug, may utilize the SSC to select a medical specialist that is educated in the pharmacology of the drug. In various embodiments, the SSC may be configured to select a specialist randomly from one or more available specialists. In various embodiments, the SSC may be configured to select from specialists based on one or more factors, such as provider identity, communication topic, specialist knowledge and/or expertise, specialist association with particular providers, geographical location, current availability, history of interaction, and/or random or pseudorandom assignment. In various embodiments, selection of specialists may be controlled in order to prevent repeated contacts between particular specialists and providers, in order to reduce the possibility of undue influence on the provider (of even of the appearance thereof). In various embodiments, the SSC may be configured to maintain information about specialists and interactions between specialists and providers in order to facilitate this selection.

In various embodiments, once a specialist has been selected, the SSC may facilitate establishment of a video and/or audio connection between the provider and the specialist. In various embodiments, the communication may be performed utilizing a device available to the provider, such as a device associated with the representative, and a device associated with the specialist. In various embodiments, the SSC may also identify, such as during establishment of a video and/or audio connection, whether sufficient bandwidth exists for particular types of connection; in scenarios where insufficient bandwidth exists, the SSC may facilitate establishment of an alternative connection between the provider and the specialist.

In various embodiments as well, the SSC may be configured to obtain information about the communication from the provider, specialist and/or representative. This information may, in various embodiments, be related to a review and/or history of the communication between the provider and the specialist. In other embodiments, the SSC may be configured to request disclosures from sensitive parties, such as providers and/or representatives. In various embodiments, records of these disclosures may be kept for historical, regulatory, and/or legal purposes. The SSC may thus provide for better record keeping of obtained disclosures, which may be of particular utility in heavily regulated industries, such as medicine.

In various embodiments, the SSC may thus provide a manner in which a representative may facilitate communication between a provider and a specialist without requiring the representative to set up the communication beforehand. The SSC may also better ensure that selection is performed and disclosures are obtained in such a manner that concerns about undue influence on the provider are kept to a minimum. This may aid the representative in the performance of his or her duties of providing information to the provider without falling afoul of legal, regulatory, or ethical rules.

It may be noted that particular examples are provided, for the sake of example, with reference to particular roles or professions. For example, embodiments are described herein with reference to “providers”, “representatives”, “specialists”, “physicians”, “medical specialists”, etc. It maybe noted, however, that various embodiments may be practiced to facilitate communication between various persons and/or roles, and that the embodiments and techniques described herein should not be read to be limited by any particular roles used for exemplary description.

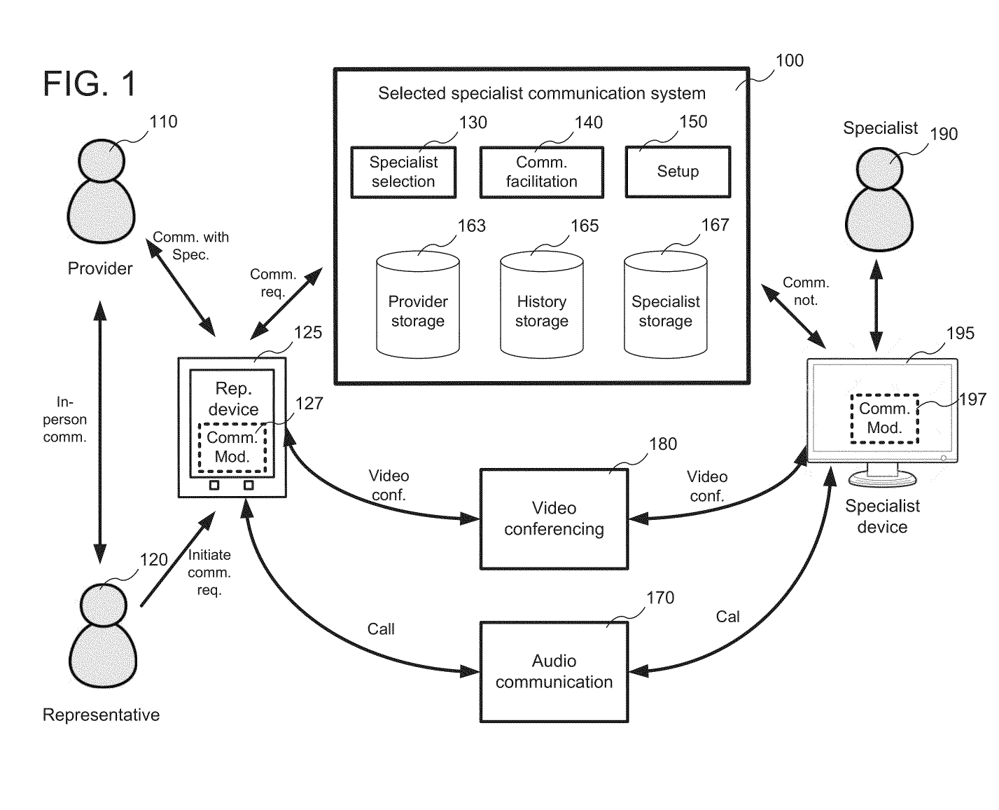

Referring now to FIG. 1, an arrangement for facilitating selected specialist communication is illustrated in accordance with various embodiments. In various embodiments, a selected specialist communication system 100 (“SSC 100”) may be configured to facilitate communication using a representative device 125 associated with a representative 120, such as to facilitate communication between a provider 110 and a specialist 190. The SSC 100 may also be configured to communicate with a specialist device 195 associated with the specialist 190. It may be noted that the representative device 125 is illustrated as a tablet, while the specialist device 195 is illustrated as a desktop computer; this particular illustration is done to show a diversity of devices. However, it may be recognized that the representative device 125 and/or the specialist device 195 may include various devices which may be suitable for communication, including, but not limited to, mobile devices and mobile phones, tablet devices, laptop computers, desktop computers, VOIP phones, video teleconferencing equipment, etc. Additionally, it may be recognized that, while the examples provided herein are made with reference to a single specialist 190, in various embodiments, multiple specialists 190 may be connected with a single provider 110, multiple providers 110 with a single specialist 190, or multiple specialists 190 may be connected with multiple providers 110. Additionally, while single devices are illustrated, in other embodiments, multiple specialist devices 195 or representative devices 125 may be utilized.

As shown in FIG. 1, examples of communication facilitated by the SSC 110 are illustrated. In various embodiments, a representative 120 may conduct in-person communication with a provider 110. For example, a pharmaceutical representative may visit a physician's office to discuss new information about a particular drug with the physician. In the course of this in-person communication the provider 110 may at some point wish to communicate with a specialist 190 about a particular topic, such as to obtain additional information, ask questions, etc. The representative 120 may then initiate a request for communication on the topic in order to facilitate the need of the provider 110. The request for communication may then be sent from the representative device 125 to the SSC 100. The SSC 100 may, in turn, select a specialist 190 from one or more available specialists 190 and then send a communications notification to the specialist 190. The SSC may subsequently initiate communications between the provider 110 and the specialist 190, such as over the representative device 125 and the specialist device 190. In various embodiments, these communications may include audio and/or video communications, such as video conferencing 180 and audio communication 190, as described herein.

In various embodiments, the representative device 125 and/or the specialist device 195 may be configured with one or more communications modules 127 and/or 197, as illustrated in FIG. 1 by the dashed line element labeled “Comm. Mod.” In various embodiments, the one or more communications modules 127 and/or 197 may be configured to communicate with the SSC 100 to aid in selection of a specialist for communication with a provider. In various embodiments, these communications modules 127 and/or 197 may be implemented in various known manners, including software, hardware, firmware, removable hardware etc. In various embodiments, the one or more communications modules 127 and/or 197 may be configured to provide interfaces for a representative 120, provider 110, and/or specialist 120 to interact with the SSC and/or during communication. In some embodiments, these interfaces may be generated by modules out of the one or more communications modules themselves. In other embodiments, the one or more communications modules 127 and/or 197 may be configured to display or otherwise present user interfaces that are generated (or otherwise provided) by the SSC 100 itself. For example, in some embodiments, the one or more communications modules 127 and/or 197 may include a browser configured to display content that is served by the SSC 100. In various embodiments, the one or more communications modules 127 and/or 197 may also be configured with audio and/or video communications abilities, such that the provider and specialist may communicate directly through the one or more communication modules 127 and/or 197. In other embodiments, other software and/or hardware may be operated on the representative device 125 and/or specialist device 195 to facilitate communication between the provider 110 and the specialist 190.

In various embodiments, the SSC 100 may itself include one or more modules which may be utilized for facilitating communication between selected specialists 190 and providers 110. As discussed herein, in these modules may be implemented in various manners, as may be understood, including software, hardware, and various combinations thereof. In some embodiments, the SSC 100 may include a specialist selection module 130 (“SSM 130”). In various embodiments, the SSM 130 may be configured to identify and select a specialist 190 from one or more available specialists 190. As discussed herein, such selection may be based, in various embodiments, on a variety of factors, including, but not limited to: provider identity, communication topic, specialist knowledge and/or expertise, specialist association with particular providers, geographical location, current availability, history of interactions with providers, etc. In various embodiments, the SSM 130 may be configured with business logic that may be operated to apply one or more business rules to these (or other) factors to provide for selection of a specialist.

In various embodiments, the SSM 130 may be configured to select specialists 190 on a random or pseudorandom fashion. In other embodiments, this random or pseudorandom fashion may include random or pseudorandom selection from amongst those specialists 190 that are available and otherwise appropriate to communicate with the provider 110 and about the requested topic. In other embodiments, the SSM 130 may deliberately choose specialists 190 with whom the provider 110 has not previously communicated or with whom the provider 110 has communicated relatively few times (such as compared with other specialists 190). In various embodiments, the use of these selection techniques may avoid a particular specialist 190 being repeatedly paired with a particular provider 110. By avoiding such frequent pairing, the SSM 100 may avoid charges of undue influence by the specialist 190 against the provider 110. This avoidance of undue influence may be particularly useful in heavily regulated industries, such as medicine.

The SSM 100 may also include a communication facilitation module 140 (“CF 140”), which may, in various embodiments, be configured to initiate video and/or audio communication between the provider 110 (e.g. using the representative device 125) and the specialist 190 (e.g., using the specialist device 195). The CF 140 may be configured to initiate communications that may be mediated by one or more other service and/or devices. For example the CF 140 may be configured to initiate video conferencing 180 using a video communication device and/or service, as illustrated. Such video conferencing devices and/or services may be understood by one of ordinary skill, but may include various video conferencing devices and/or services that may be implemented on computing devices, mobile devices, laptop or desktop computers, dedicated video conferencing hardware, etc. It may also be noted that, while FIG. 1 illustrates video conferencing 180 as occurring between the representative device 125 and the specialist device 190, in some embodiments other devices, such as telephonic equipment, dedicated video conferencing software/hardware, etc., may be used for video conferencing.

In some other embodiments, the CF 140 may be configured to initiate audio communications 170 between the specialist 190 and the provider 110. In various embodiments, the audio communication 170 may be performed, as illustrated, between the representative device and the specialist device. In other embodiments, the CF 140 may facilitate audio communication 170 using other equipment, such as telephony equipment (including, e.g. POTS equipment and/or VOIP equipment), or computer-based audio communications, such as Skype or similar services.

In some embodiments, the CF 140 may also be configured to measure bandwidth available for communication and to modify usage of particular forms of communication that better fit bandwidth availability. For example, the CF 140 may be configured to require that only audio communications 170 be allowed if bandwidth is sufficiently low, and/or to downgrade video or audio communications quality to ensure continued communication. These actions of measuring and modifying usage may be performed prior to and/or during communications, in various embodiments.

The CF 140 may also facilitate obtaining information from the provider and/or the specialist. In various embodiment, this information may include ratings, reviews, and/or notes about a particular communication session, a particular provider 110, or a particular specialist 190. The CF 140 may also be configured to request and record disclosure confirmations from one or more of the provider 110, representative 120, and/or specialist 190, as described herein.

Also as illustrated in FIG. 1, the SSC 100 may include various storage modules, which may be configured to receive and maintain information received by the CF 140 and to provide such information to the SSM 100 and/or CF 140 to facilitate the activities performed thereby. These storage modules may include: provider storage 163, configured to store, for example, information about providers 110; history storage 165, configured to store, for example, information relating to historical interactions between providers 110, representatives 120, and/or specialists 190; and specialist storage 167, configured to store, for example, information relating to specialists 190. Additionally, the SSC 100 may also include a setup module 150 (“SM 150”) which may be configured, in various embodiments, to receive and store such information prior to communications described herein. The SM 150 may also be configured to add to such information outside of the context of particular communications on an ongoing basis. The SSM 100 may, in various embodiments, include other modules and/or facilities not illustrated in FIG. 1, as may be described herein.

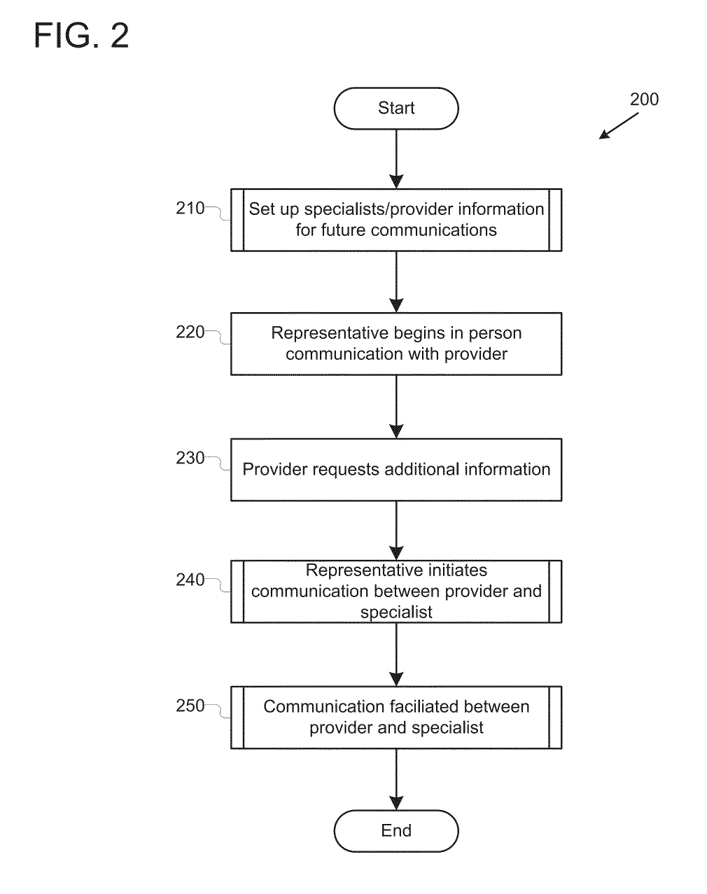

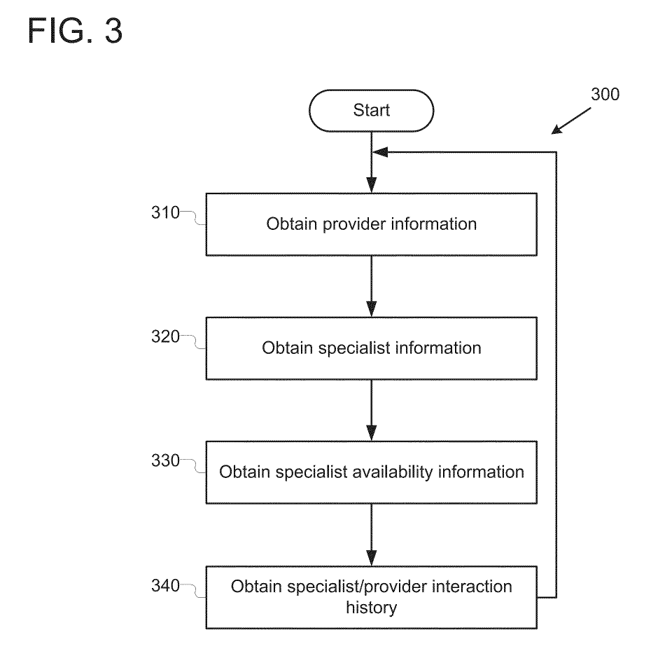

Referring now to FIG. 2, an example process 200 for facilitating selected specialist communication is illustrated in accordance with various embodiments. While FIG. 2 illustrates particular example operations, in various embodiments, the process may include additional operations, omit illustrated operations, and/or combine illustrated operations. The process may begin at operation 210, where the SSC 100 and in particular, the SM 150, may setup information about specialists 190 and/or providers 120 in order to facilitate future selection of specialists 190 and communication between providers 120 and specialists 190. Particular implementations of operation 210 are described below with reference to process 300 of FIG. 3. It may be noted as well that, while the process of FIG. 2 illustrates operation 210 as occurring in an initial point in time, in various embodiments, operation 210 may be performed before, during, or after communications and/or may be repeated.

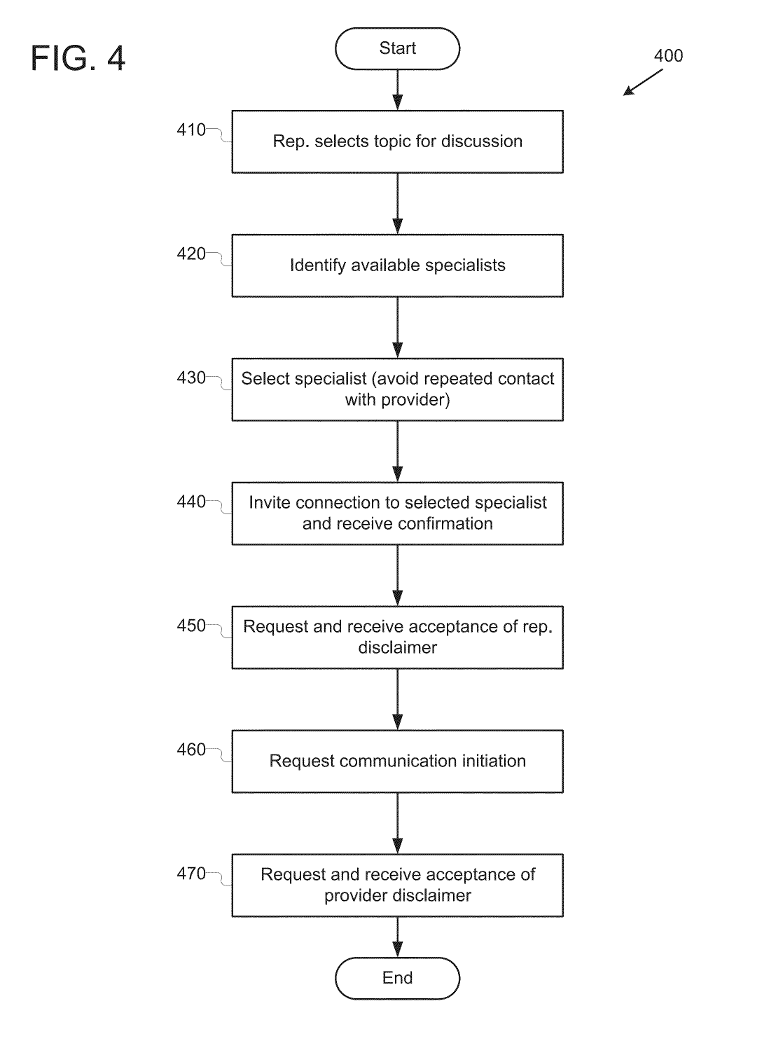

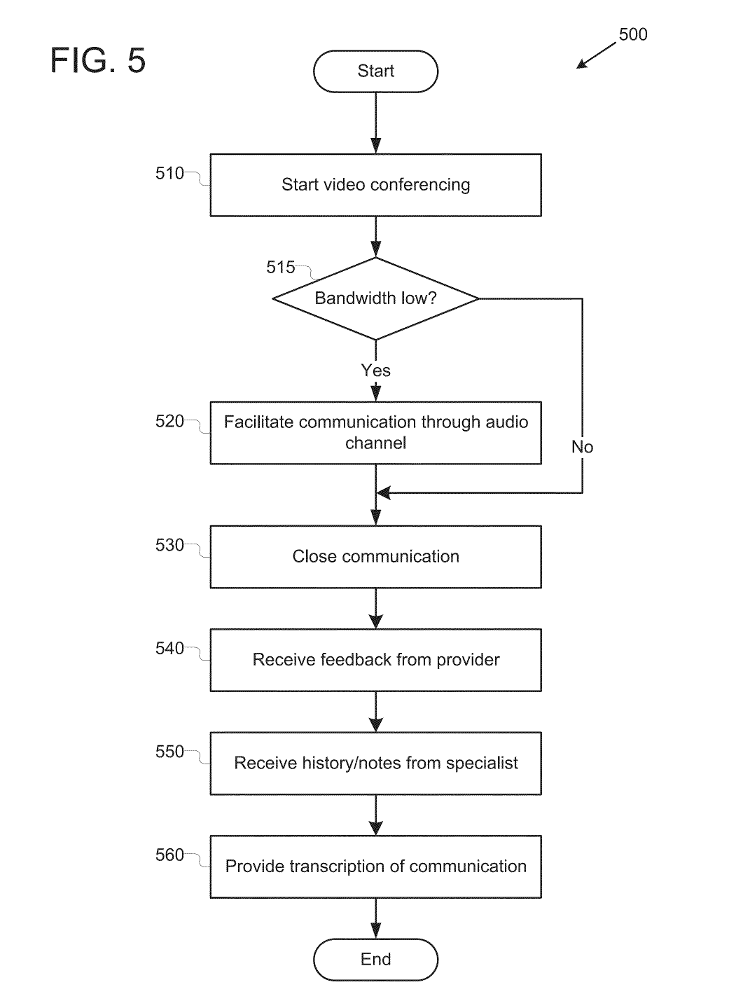

Next, at operation 220, in various embodiments, the representative 120 may begin an in-person communication with the provider 110. Next, at operation 230, the provider 110 may request additional information, such as information that cannot be provided by the representative 120, such as due to regulatory requirements and/or knowledge of the representative. At operation 240, the representative 120 may then initiate communication between provider 110 and a specialist 190. This request may be performed in various embodiments using the one or more communications modules 127 of the representative device 125. Particular implementations of operation 240 are described below with reference to process 400 of FIG. 4. Next, the SSC 100 may facilitate communication between the provider 110 and the specialist 190. Particular implementations of operation 250 are described below with reference to process 500 of FIG. 5. The process may then end.

Referring now to FIG. 3, an example process 300 for setting up information about specialists and/or providers is illustrated in accordance with various embodiments. While FIG. 3 illustrates particular example operations, in various embodiments, the process may include additional operations, omit illustrated operations, and/or combine illustrated operations. In various embodiments, process 300 may include one or more implementations of operation 210 of FIG. 2. In various embodiments, the process of FIG. 3 may be performed by the SM 150, and may include operations by the provider storage 163, history storage 165, and or specialist storage 167. The process may begin at operation 310 where the SM 150 obtains provider information for one or more providers 110. In various embodiments, this information may include, but is not limited to: geographical location; association with particular provider facilities, hospitals, hospital networks, distributor networks, call centers, practices and/or clinics; association with particular professional groups; practice specialties; patient population information; preferred language; etc. The information thus obtained may be provided to and stored by the provider storage 163. Next, at operation 320, the SM may obtain specialist information for one or more specialists. In various embodiments, this information may include, but is not limited to: geographical location; educational background; degrees; professional certifications; expertise in particular areas of disease, pharmacology, and/or pathologies; expertise with particular drugs, devices, and/or other products; feedback ratings, language facility; etc. In various embodiments, this information may also include personal information about the specialist 190, such as personal interests or interest associations.

Next, at operation 330, the SM 150 may obtain availability information for specialists 190. In various embodiments, this information may include, but is not limited to: time availability; date availability; connection bandwidth; etc. In various embodiments, this information may also include information about particular providers 110 that a particular specialist 190 has been associated with. For example, in some embodiments, one or more medical specialists may be associated ahead of time with a particular group of physicians in order to better ensure that specialists are available when needed for communications. At operation 340, the SM 150 may then obtain specialist 190/provider 110 interaction histories. In various embodiments, such history may include notes about particular interactions between the provider 110 and the specialist 190, modes of communication (by phone, video conference, email, etc.), ratings or review of specialists 190 by providers 110, etc. After completion of the various operations for obtaining information, the SM 150 may repeat the process, in whole or in part, at various times.

Referring now to FIG. 4, an example process 400 for initiating communication between a provider and a specialist is illustrated in accordance with various embodiments. While FIG. 4 illustrates particular example operations, in various embodiments, process 400 may include additional operations, omit illustrated operations, and/or combine illustrated operations. In various embodiments, process 300 may include one or more implementations of operation 240 of FIG. 2. In various embodiments, the process of FIG. 4 may be performed by various entities, including the SSM 100, and the one or more respective communications modules 127 and/or 197 of the respective representative device 125 and/or the specialist device 195, and may include operations by the provider storage 163, history storage 165, and or specialist storage 167. The process may begin at operation 410, where the representative 120 may select a topic for discussion between the provider 110 and the specialist 190. In various embodiments, topics selected in this operation may include, but are not limited to: pharmaceuticals, prescription of pharmaceuticals, off-label usage of pharmaceuticals, medical devices usage and prescription thereof, medical techniques, etc. In some embodiments, the one or more communication modules 127 of the representative device 125 may be configured to present one or more pre-selected topics. In various embodiments, the one or more communication modules 127 of the representative device 125 may be configured to present the pre-selected topics based on specialists 190 which are available at the time of the in-person communication.

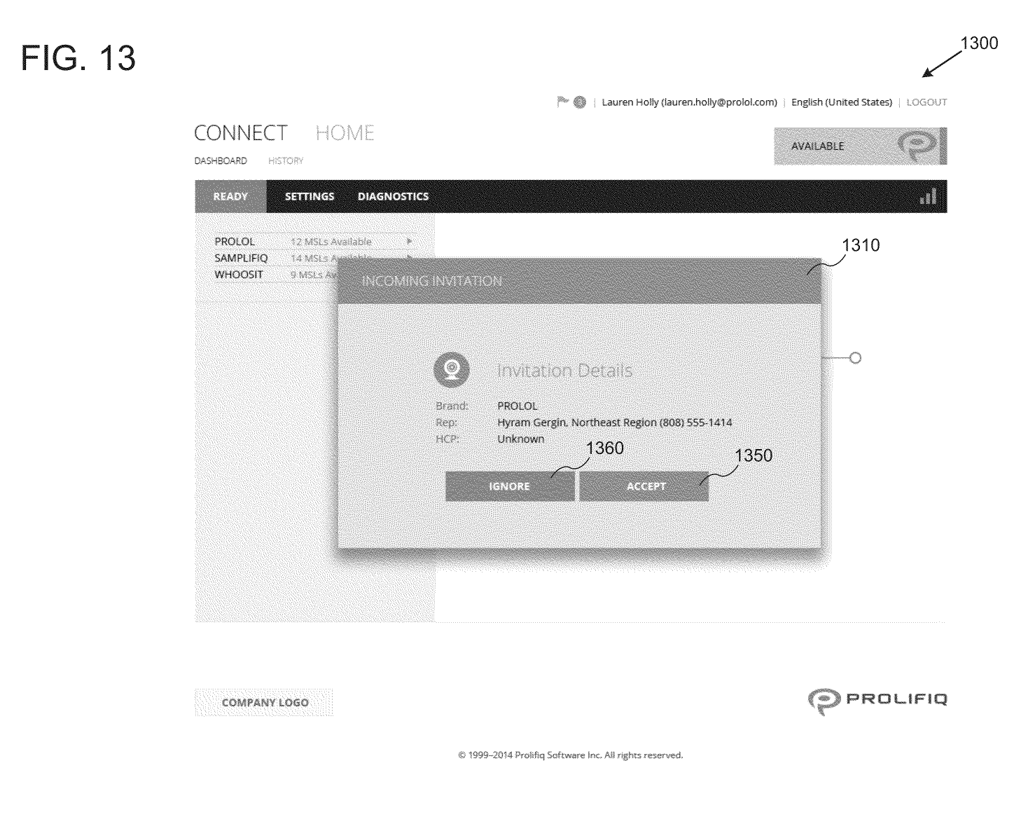

Next, at operation 420, the SSM 100 may identify available specialists 190 that are available (and qualified) to communicate about the selected topic. In various embodiments, the SSM 100 may identify these specialists 190 based on availability and knowledge/expertise information that is maintained at the specialist storage 167. Subsequently, at operation 430, the SSM 100 may select a specialist 190. As discussed above, the SSM 100 may select a specialist 190 in a manner to minimize or avoid selection of a specialist 190 that has had repeated contact with the provider 110, such as by selecting a specialist 190 in a random or pseudorandom manner. In other embodiments, the SSM 100 may be configured to avoid selection of a specialist 190 that has had recent and/or repeated contact with the provider 110. As discussed above, the SSM 100 may be configured to apply one or more business rules during this operation to select a specialist 190, such as to information stored in provider storage 163, history storage 165, and or specialist storage 167. For example, in order to select a specialist, the SSM 100 may apply business rules to information including, but not limited to: provider identity, communication topic, specialist knowledge and/or expertise, specialist association with particular providers, geographical location, current availability, history of interactions with providers, etc. After selection of a specialist 190, at operation 440 the SSM 100 may send an invitation to the selected specialist 190 requesting to begin the communication, and may receive a confirmation from the specialist 190. Particular examples of this indication are provided below at FIG. 13. In various embodiments, if the specialist 190 elects to refuse the connection, the SSM 100 may repeat the selection and invitation operations for a different specialist.

In alternative embodiments, a specialist 190 may be selected at operation 430 who is no longer available (such as if they were asked to participate in a different communication or if they had to step away from their desk). In such scenarios, the specialist 190 not accept the invitation at 440. In various embodiments, the SSM 100 may allow the provider 110 to schedule a future appointment with the selected specialist 190. In various embodiments, the future appointment may be scheduled for in-person communication or for communication using the audio or video communication techniques described herein.

After receiving confirmation, at operation 450, the one or more communications modules 127 of the representative device 125 may request and receive certification of one or more disclaimers by the representative 120. In various embodiments the one or more disclaimers may be presented to the representative 120 to better ensure compliance with legal, regulatory, and/or ethical rules. In one example, the representative 120 may be asked to certify that they will not be physically present during the communication between the provider 110 and the specialist 190. In another example, the representative 120 may be asked to certify that they did not ask for or otherwise encourage the communication between the provider 110 and the specialist 190. In various embodiments, the representative 120 may certify that they accept the disclaimer in various manners, such as by selecting an “Accept” user interface element, checking a box, signing a signature, providing a password, or other methods.

After the disclaimer acceptance is certified, at operation 460, the provider 110 or representative 120 may indicate that the provider 110 wishes to initiate the communication with the selected specialist 190. In various embodiments, the one or more communications modules 127 of the representative device 125 may be configured to present a user interface element to receive such an initiation request. In some embodiments, the one or more communications modules 127 may be configured to not present the user interface element until such a time that the specialist 190 has been selected (and/or identified to the provider 110) and/or the disclaimer certified by the representative 120. Once the request to initiate communication has been received, the one or more communications modules 127 of the representative device 125 may request and receive acceptance of one or more disclaimers from the provider 110. Similar to the disclaimers mentioned above, the one or more disclaimers may be presented to the provider 110 to better ensure compliance with legal, regulatory, and/or ethical rules. In one example, the provider 110 may be asked to certify that the representative 120 will not be physically present during the communication between the provider 110 and the specialist 190. In another example, the provider 110 may be asked to certify that they were not improperly influenced (such as by the representative 120) in their decision to request the communication with the specialist 190. In various embodiments, the provider 110 may certify that they accept the disclaimer in various manners, such as by selecting an “Accept” user interface element, checking a box, signing a signature, providing a password, or other methods. It maybe noted that, in both certification operations described above, that records of the certifications may be provided to the SSC 100 and that these records may be recorded, such as in the history storage 165 of the SSC 100. After the disclaimer certification is received from the provider 110, the process may then end.

Referring now to FIG. 5, an example process 500 for facilitating communication between the provider 110 and the specialist 190 is illustrated in accordance with various embodiments. While FIG. 5 illustrates particular example operations, in various embodiments, the process may include additional operations, omit illustrated operations, and/or combine illustrated operations. In various embodiments, process 500 may include one or more implementations of operation 250 of FIG. 2. In various embodiments, process 500 of FIG. 5 may be performed by various entities, including the CF 140, and the one or more communications modules 127 and or 197 of the representative device 125 and/or the specialist device 195, and may include operations by the provider storage 163, history storage 165, and or specialist storage 167. The process may begin at operation 510, where the CF 140 may start a video conferencing connection. In various embodiments, the video conferencing connection may include various forms and implementations of video conferencing 180, as may be understood. Additionally, as discussed above, in various embodiments, the CF 140 may facilitate a connection that is mediated by video conferencing modules, as discussed above. Next, at decision operation 515, the CF 140 may determine if the bandwidth is too low for successful video conferencing. If so, then at operation 520, the CF 140 may facilitate audio communication 170 through an audio channel in lieu of the video conferencing. In some embodiments, the CF 140 may provide one or more phone numbers which the provider 110 and specialist 190 may call in order to be connected for audio communication 170. In other embodiments, audio communication 170 may be facilitated in other manners.

After the communication is completed (whether by video conferencing 180 or audio communication 170) at operation 530, the communication may subsequently be closed. After close of the communication, at operation 540 the CF 140 may receive feedback on the communication from the provider 110. In various embodiments, this feedback may include ratings, reviews, notes, or other feedback on the quality and/or content of the communication. In various embodiments, all or part of this feedback may be stored in the history storage 165 and/or specialist storage 167. The stored feedback may, in various embodiments, be used a factors during later selection of specialists 190 by the SSM 130. In various embodiments, the one or more communication modules 127 of the representative 120 device may be configured to request and receive this feedback and to provide it to the CF 140. At operation 550 the CF 140 may receive history or notes from the specialist 190 about the communication (such as from the one or more communication modules of the specialist device). These notes may also be stored, such as in the history storage 165 or the specialist storage 167.

At operation 560, the CF 140 may provide a transcript of the communication. In various embodiments, the transcript may be provided by converting audio of the conversation into text. In other embodiments, text, images, and/or video from a video conference may be included in the transcript. In other embodiments, interactions may be recorded during the communication, such as taps or highlights; these interactions may be included in transcripts. In various embodiments, the transcript may be provided to one or more of the specialist 190, the provider 110, and/or the representative 120. In various embodiments, the transcript may also be stored, such as in a medical records database, for later retrieval. Finally, in various embodiments, the CF 140 may receive from the provider 110 a request for a future communication with the specialist 190 (not illustrated). In various embodiments, the CF 140 may then schedule a future appointment for in-person communication or for communication using the audio or video communication techniques described herein. The process may then end.

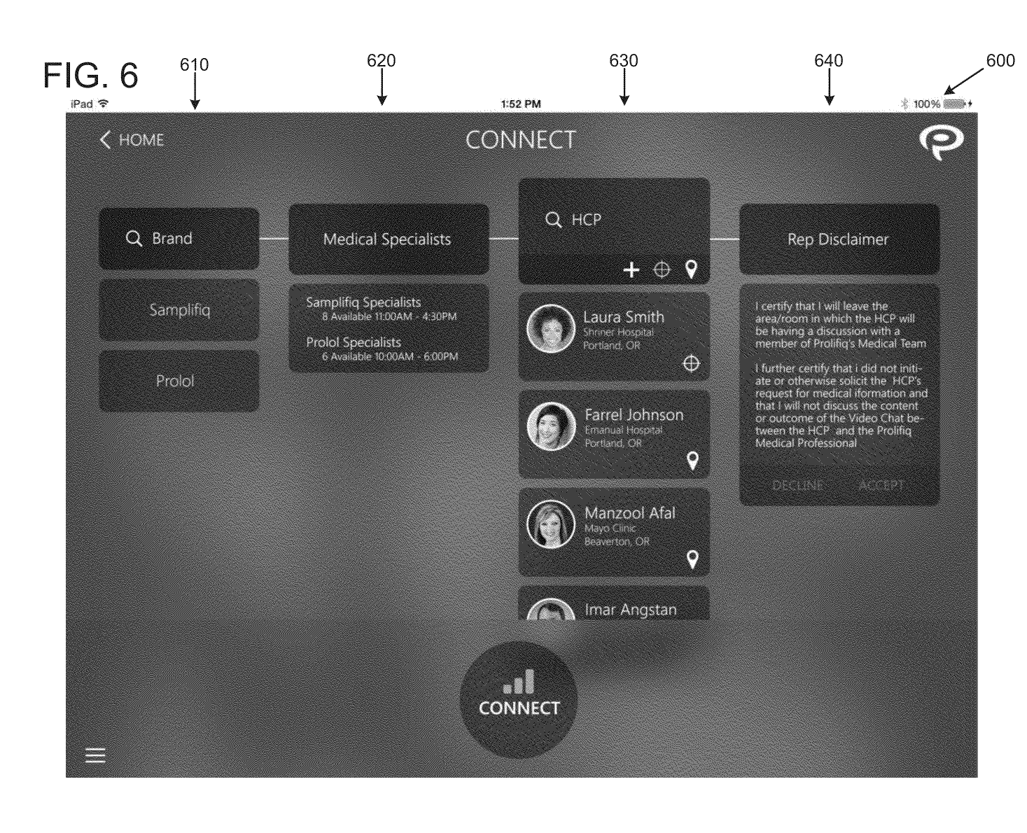

Referring now to FIGS. 6-11, example interfaces provided by the one or more communication modules 127 of the representative device 125 are illustrated according to some of the techniques described herein. While particular example interfaces are illustrated, in various embodiments, other interfaces may be utilized. Additionally, while the examples of FIGS. 6-11 may be generated by the one or more communication modules 127 of the representative device 125, in other embodiments, the interfaces may be generated, in whole or in part, by modules at the SSC 100 and merely presented by the communication modules 127 of the representative device 125 (e.g., the one or more communications modules 127 may include a browser displaying one or more web pages provided by the SSC 100).

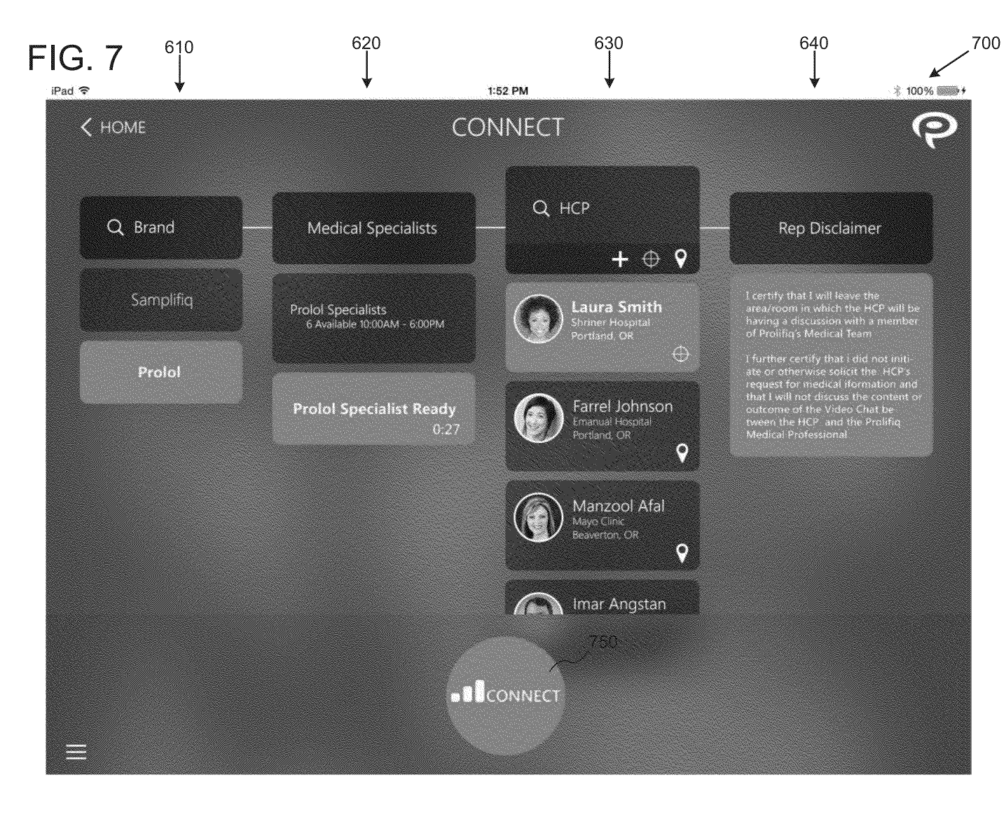

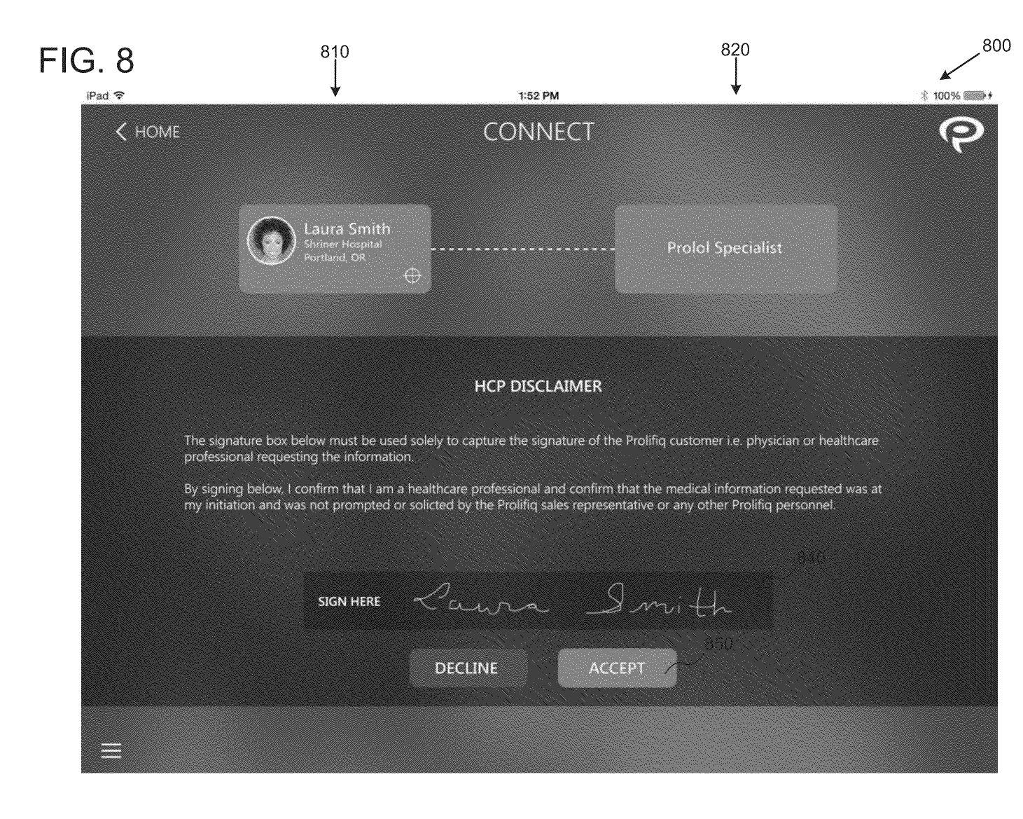

In FIG. 6, a connection screen 600 is illustrated. The connection screen 600 shows a list 610 of pharmaceutical brands which may be utilized as topics for communication. The connection screen also shows a list 620 of medical specialists according to the pharmaceutical brands, including how many specialists are currently available for each brand. The connection screen also shows a list 630 of health care providers which may be selected to indicate which provider may wish to communicate with a specialist. The connection screen also shows a disclaimer 640 for the representative, which may be confirmed through a selection of an “Accept” user interface element. In FIG. 7, an example 700 is shown with a selection before initiation of a communication session. In the example selection, the provider has asked for communication with a specialist about the fictitious drug “prolol” and the representative has selected prolol from the list of brands and the provider from the list of providers. The SSM has indicated, through his user interface, that a prolol specialist is ready to begin communication and the representative has confirmed the representative disclaimer. At this point, the interface has presented a “Connect” user interface element 750 which may be selected by the provider to initiate communications. Next, in the interface 800 of FIG. 8, the provider and the topic are identified at 810 and 820, respectively, and a disclaimer certification is requested from the provider. In the example of FIG. 8 the provider disclaimer certification requires a signature at a signature entry element 840 in addition to an “Accept” selection 850, as shown.

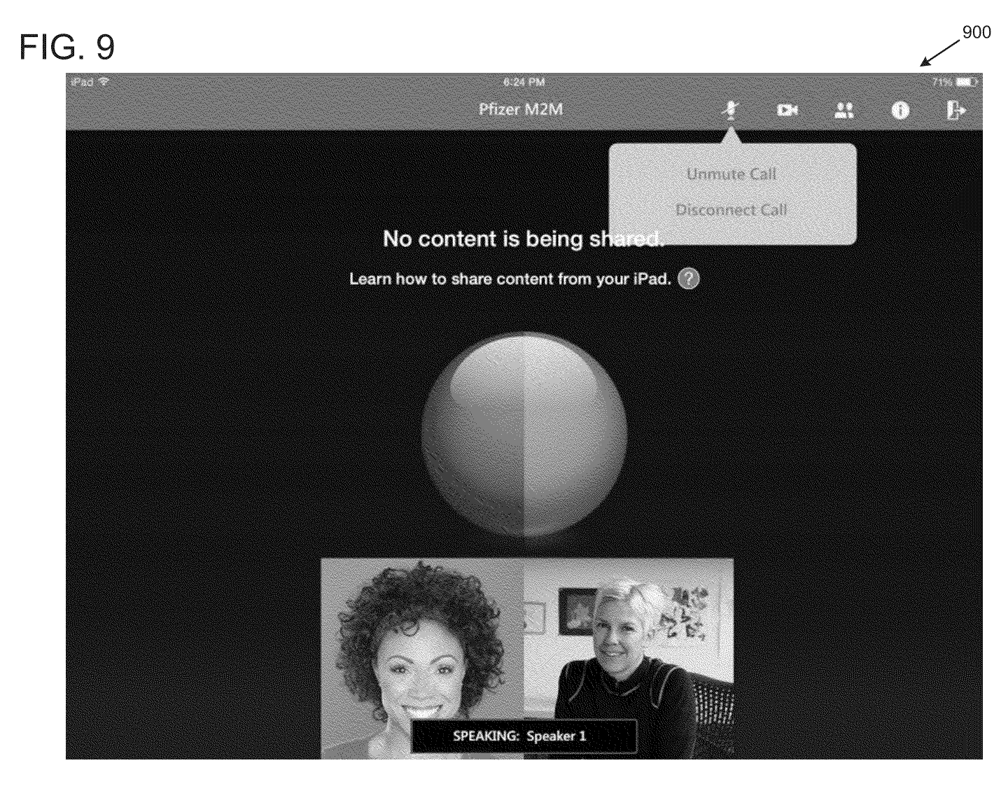

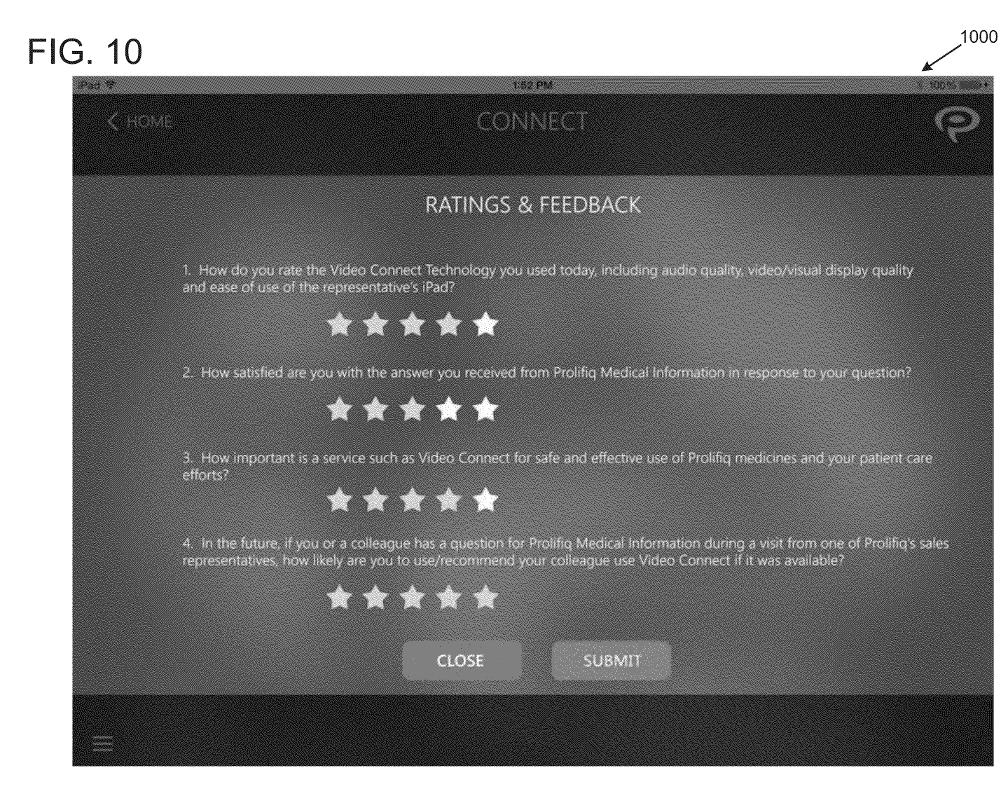

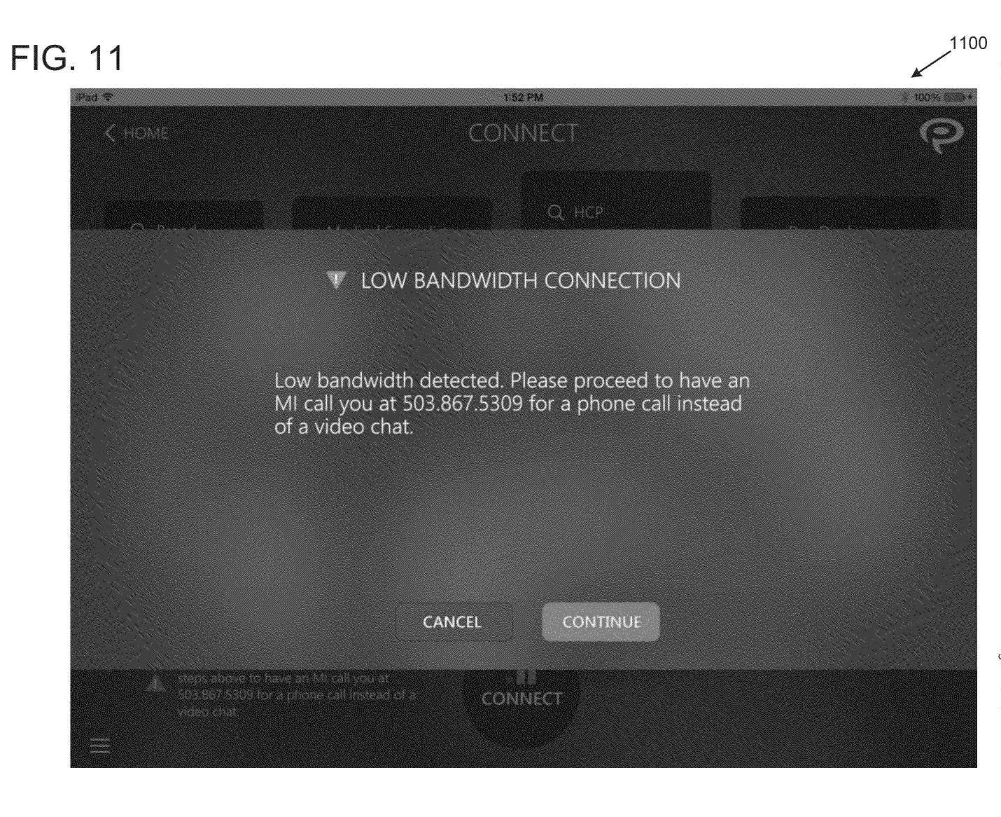

FIG. 9 illustrates an example video communication interface 900 for communication between a provider 110 and a specialist 190. In the example of FIG. 9, the specialist 110 and the provider 190 may see each other and may communicate using video and audio. Additionally, one or both parties may mute their audio, share content resident on their respective devices, and perform other video conferencing activities, as my be understood. Next, at FIG. 10, an interface 1000 is provided to the provider 110 for leaving feedback on the communication. In the example, the provider 110 is asked to submit ratings for both the content of the communication as well as the quality of the communication technology itself. In various embodiments, other feedback may be requested, including free-form feedback. At FIG. 11, an interface 1100 is shown that may be displayed on the representative device when bandwidth is determined to be too low. In this case, the provider 110 may be asked to allow the specialist 190 to call them at a pre-defined number (which may, in various embodiments, be a number of the provider or may be an audio conference number). The provider 110 may be allowed to select a “Continue” user interface element in order to signal that the specialist may contact them for an audio communication.

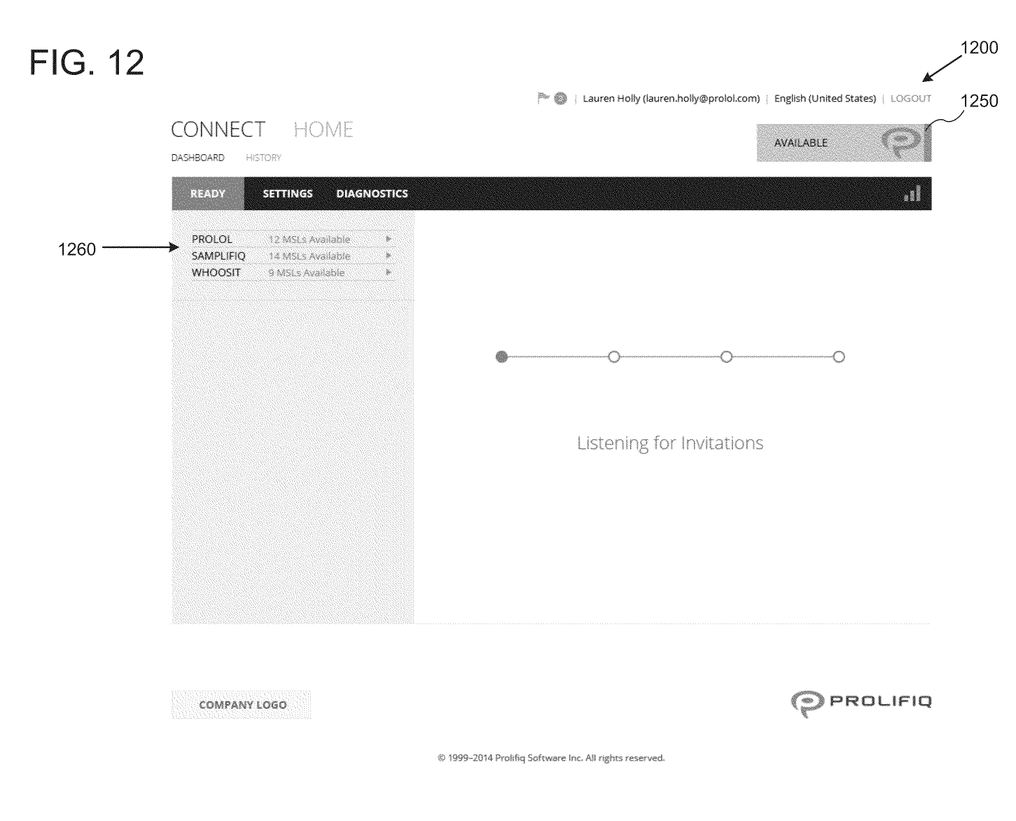

Referring now to FIGS. 12-17, example interfaces provided by the one or more communication modules 197 of the specialist device 195 are illustrated according to various embodiments. While particular example interfaces are illustrated, in various embodiments, other interfaces may be utilized. Additionally, as discussed above, the interfaces illustrates may be generated by the one or more communication modules 197 of the specialist device 195 and or by modules at the SSC 100 and subsequently presented by the one or more communication modules 197 of the specialist device 195.

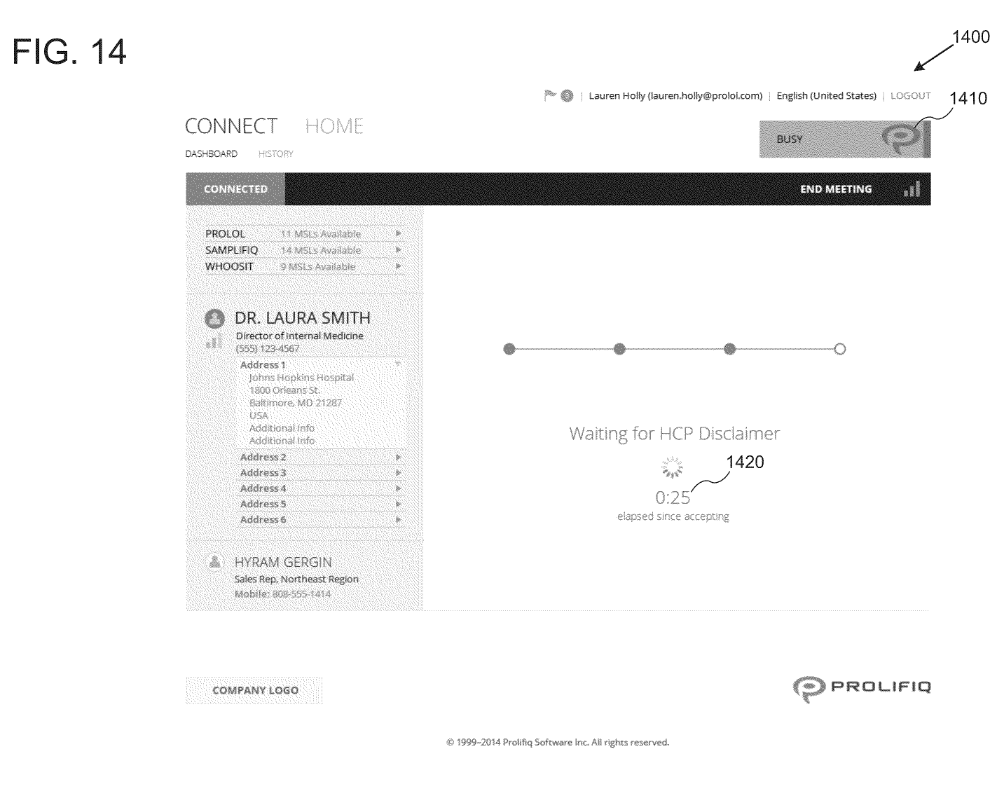

FIG. 12 shows an interface 1200 which may be presented to the specialist 190 when the specialist 190 is available for a communication but is not currently communicating. In the example, the specialist 190's available status is illustrated at element 1250, along with statuses of other specialists 190 at element 1260. The interface 1200 also shows that the SSM 130 is listening for requests for communications. At FIG. 13 an interface 1300 is shown where the SSM 130 has selected the specialist and the specialist has received an invitation to communicate with a provider, shown at element 1310. The topic of the communication and the representative identity are shown at element 1310. In some embodiments, the provider identity may also be shown to the specialist. The specialist is also provided with interface elements 1350 and 1360 to, respectfully, accept the invitation or to ignore the invitation, as shown. Next, at FIG. 14, an interface 1400 is shown where the specialist 190 has accepted the invitation and is waiting for the connection to begin. In this example interface, the provider is identified. Additionally, the specialist 190 is given an elapsed time at element 1420, which may be utilized by the specialist in the case that a connection is not initiated, if that specialist 190 wishes to cancel the connection. The specialist's status is also indicated as “Busy” at element 1410, which may indicate, in various embodiments, that the specialist 190 may not receive invitations to connect until/unless they later become available.

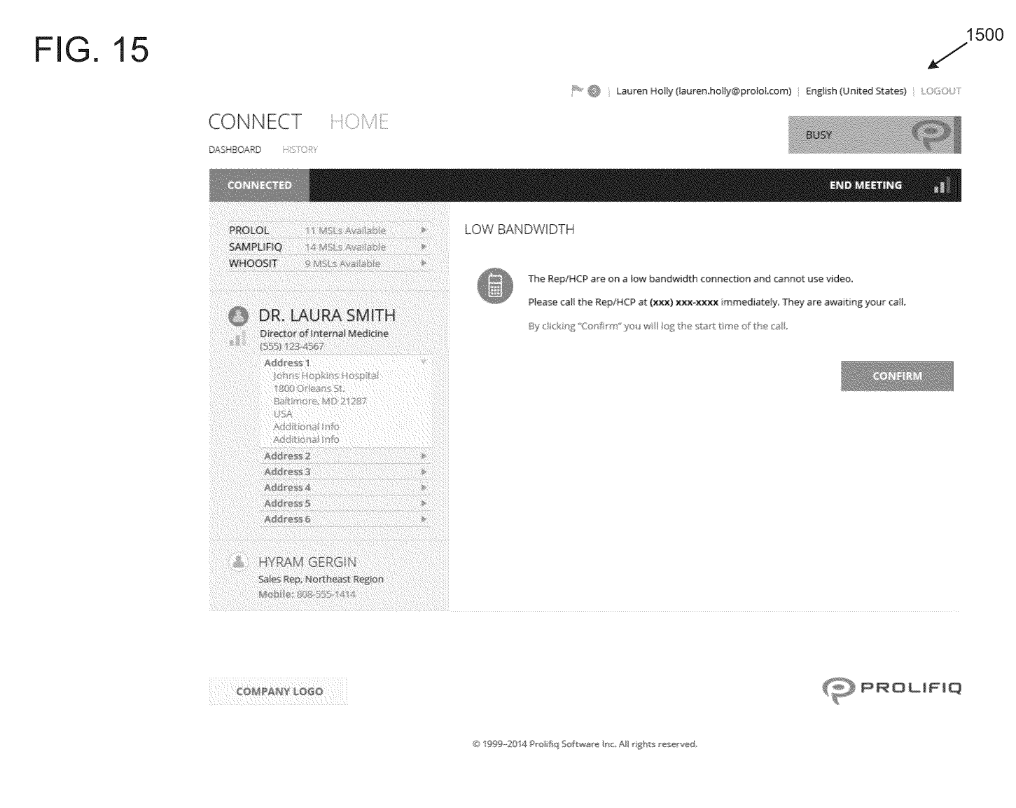

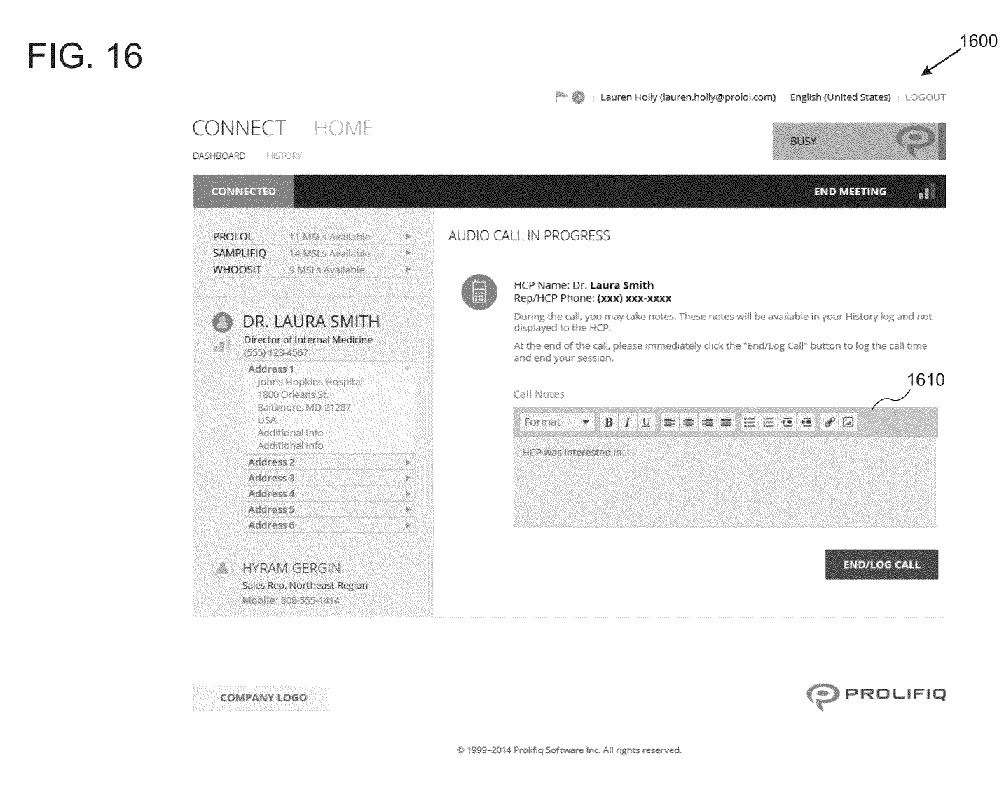

At FIG. 15, an interface 1500 is shown when the CF has determined that bandwidth is insufficient for a video connection. In this example, the specialist is asked to contact the provider through an audio call, as discussed above. At FIG. 16, an interface 1600 is shown that may be presented during this audio call, along with a “Call notes” section 1610, where the specialist may record notes on the call and submit these notes for storage (e.g. storage in the history storage of the SSC). This notes section may be of particular interest after audio calls, as the calls may not be performed through the representative and/or specialist devices 125 and 195, and there thus may be little to no record of the call.

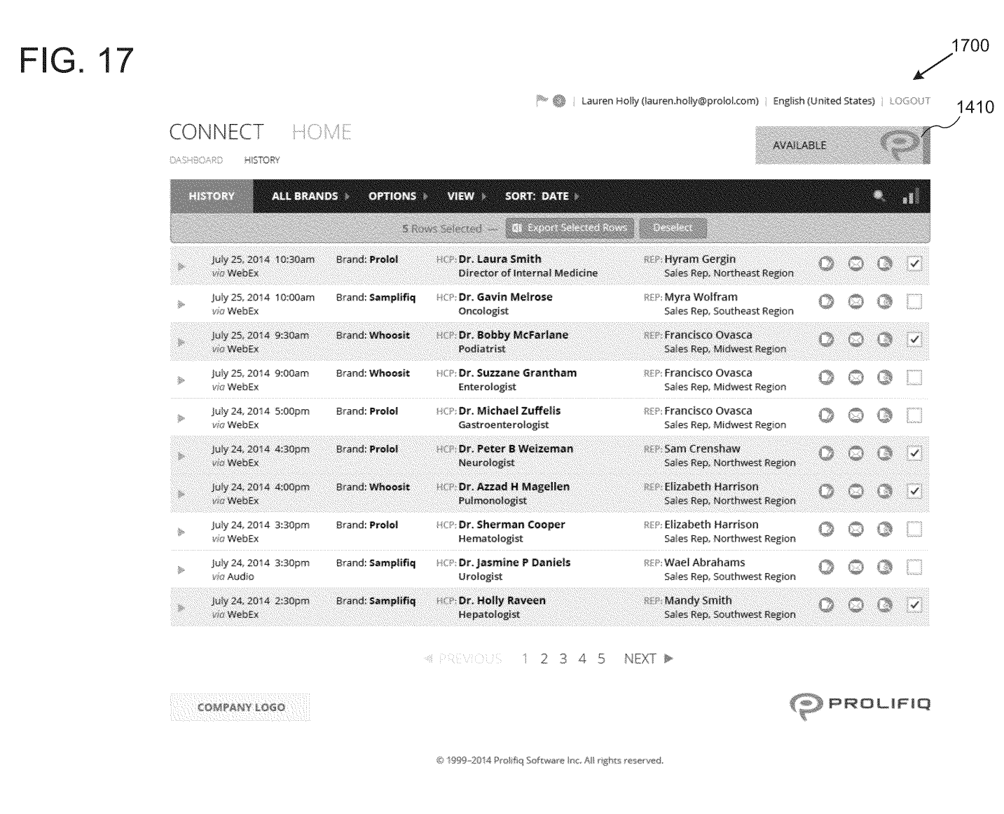

Finally, at FIG. 17, a history interface 1700 is illustrated, whereby the specialist 190 (or other user) may view histories of interactions between providers 110 and specialists 190. In various embodiments, one or more providers 110, specialists 190, or interactions may be selected, modified, and/or exported for review. In various embodiments, history information may also include, but is not limited to, additional actions that are performed, recommendations made, both in the past and for the future, or other information that is included from other systems.

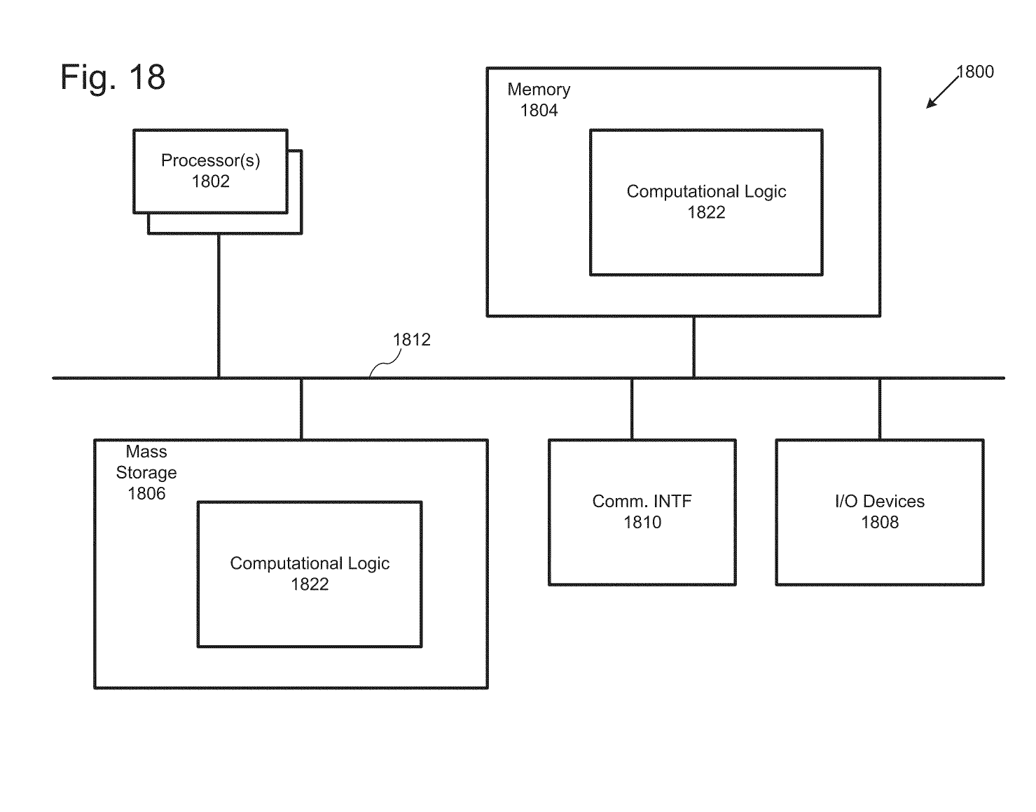

Referring now to FIG. 18, an example computer suitable for practicing various aspects of the present disclosure, including processes described herein, is illustrated in accordance with various embodiments. As shown, computer 1800 may include one or more processors or processor cores 1802, and system memory 1804. For the purpose of this application, including the claims, the terms “processor” and “processor cores” may be considered synonymous, unless the context clearly requires otherwise. Additionally, computer 1800 may include mass storage devices 1806 (such as diskette, hard drive, flash drive, solid state drive, compact disc read only memory (CD-ROM) and so forth), input/output devices 1808 (such as display, keyboard, cursor control, remote control, gaming controller, image capture device, and so forth) and communication interfaces 1810 (such as network interface cards, modems, infrared receivers, radio receivers (e.g., Bluetooth), and so forth). The elements may be coupled to each other via system bus 1812, which may represent one or more buses. In the case of multiple buses, they may be bridged by one or more bus bridges (not shown). Elements such as mass storage may be physically separate or remote.

Each of these elements may perform its conventional functions known in the art. In particular, system memory 1804 and mass storage devices 1806 may be employed to store a working copy and a permanent copy of the programming instructions implementing the operations associated with facilitation of communication with selected specialists as shown in processes described herein. The various elements may be implemented by assembler instructions supported by processor(s) 1802 or high-level languages, such as, for example, C, that can be compiled into such instructions.

The permanent copy of the programming instructions may be placed into permanent storage devices 1806 in the factory, or in the field, through, for example, a distribution medium (not shown), such as a compact disc (CD), or through communication interface 1810 (from a distribution server (not shown)). That is, one or more distribution media having an implementation of the processes described herein may be employed to distribute the programming instructions and program various computing devices.

The number, capability and/or capacity of these elements 1810-1812 may vary, depending on how computer 1800 is used. Their constitutions are otherwise known, and accordingly will not be further described.

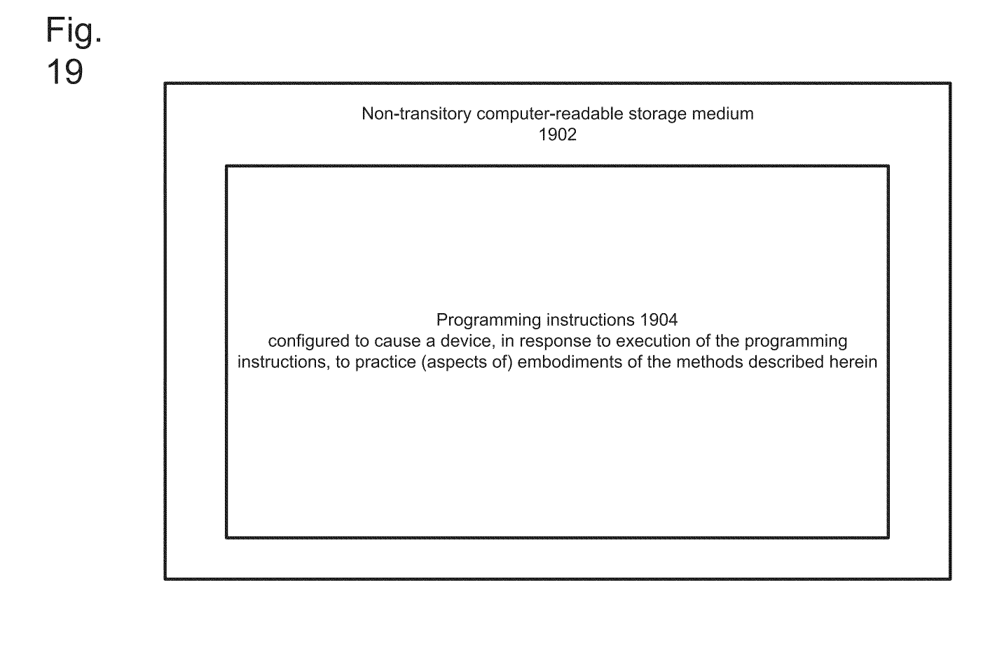

FIG. 19 illustrates an example least one computer-readable storage medium 1902 having instructions configured to practice all or selected ones of the operations associated with techniques described herein. As illustrated, least one computer-readable storage medium 1902 may include a number of programming instructions 1904. Programming instructions 1904 may be configured to enable a device, e.g., computer 1800, in response to execution of the programming instructions, to perform, e.g., various operations of processes described herein, but not limited to, to the various operations performed to modify and share content. In alternate embodiments, programming instructions 1904 may be disposed on multiple computer-readable storage media 1602 instead.

Referring back to FIG. 18, for one embodiment, at least one of processors 1802 may be packaged together with computational logic 1822 configured to practice aspects of processes described herein. For one embodiment, at least one of processors 1802 may be packaged together with computational logic 1822 configured to practice aspects of processes of described herein to form a System in Package (SiP). For one embodiment, at least one of processors 1802 may be integrated on the same die with computational logic 1822 configured to practice aspects of processes of described herein. For one embodiment, at least one of processors 1802 may be packaged together with computational logic 1822 configured to practice aspects of processes of described herein to form a System on Chip (SoC). For at least one embodiment, the SoC may be utilized in, e.g., but not limited to, a computing tablet.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A method for facilitating communication between a first party and a second party, the method comprising:
receiving, by a computing system, a request for a communication between the first party and a second party, by a third party physically present with the first party, on a device controlled by the third party;
selecting, by the computing system, from among one or more second parties, a second party that is available for a communication;
receiving, by the computing system, from the device, indications of regulatory compliance relating to potential communications between the first party and the second party; and
based on receipt of the indications of regulatory compliance from the device, initiating, by the computing system, communication between the first party and the second party using the device.

2. The method of claim 1, wherein selecting the second party comprises selecting a second party that is currently available for communication.

3. The method of claim 1, wherein selecting the second party comprises applying one or more business rules to information relating to the second party.

4. The method of claim 3, wherein selecting the second party comprises applying one or more business rules to one or more of: an identity of the first party, an identity of the second party, one or more areas of expertise of the second party, a topic for the communication, or a geographical location of the first or second party.

5. The method of claim 1, wherein selecting a second party comprises selecting a second party based at least in part on past communications between the selected second party and the first party.

6. The method of claim 5, wherein selecting a second party based at least in part on past communications between the selected second party and the first party comprises not selecting the second party if the second party has communicated with the first party within a pre-set timeframe or has exceeded a pre-set number of communications with the first party.

7. The method of claim 1, wherein:
receiving a request for a communication comprises receiving a request for a communication on a specific subject; and
selecting a second party comprises selecting a second party that is associated with communication on that subject.

8. The method of claim 1, wherein receiving indications of regulatory compliance comprises receiving indications that the third party has will not be present during the communication.

9. The method of claim 1, wherein receiving indications of regulatory compliance comprises receiving indications that the third party has not unduly influenced the first party.

10. The method of claim 1, wherein receiving indications of regulatory compliance comprises receiving indications from one or more of the first party or the second party.

11. The method of claim 1, wherein initiating communication comprises initiating a video conferencing session.

12. The method of claim 11, further comprising:
determining, by the computing system, that quality for the video conferencing session has fallen below a pre-set threshold; and
transitioning, by the computing system, communication to an audio channel.

13. One or more non-transitory computer-readable media containing instructions written thereon that, in response to execution by a computing system, cause the computing system to:
receive a request for a communication between the first party and a second party, by a third party physically present with the first party, on a device controlled by the third party;
select, from among one or more second parties, a second party that is available for a communication;
receive, from the device, indications of regulatory compliance relating to potential communications between the first party and the second party; and
based on receipt of the indications of regulatory compliance from the device, initiate communication between the first party and the second party using the device.

14. The one or more non-transitory computer-readable media of claim 13, wherein select the second party comprises select a second party that is currently available for communication.

15. The one or more non-transitory computer-readable media of claim 13, wherein select the second party comprises apply one or more business rules to information relating to the second party.

16. The one or more non-transitory computer-readable media of claim 15, wherein select the second party comprises apply one or more business rules to one or more of: an identity of the first party, an identity of the second party, one or more areas of expertise of the second party, a topic for the communication, or a geographical location of the first or second party.

17. The one or more non-transitory computer-readable media of claim 13, wherein select a second party comprises select a second party based at least in part on past communications between the selected second party and the first party.

18. The one or more non-transitory computer-readable media of claim 17, wherein select a second party based at least in part on past communications between the selected second party and the first party comprises not select the second party if the second party has communicated with the first party within a pre-set timeframe or has exceeded a pre-set number of communications with the first party.

19. The one or more non-transitory computer-readable media of claim 13, wherein:
receive a request for a communication comprises receive a request for a communication on a specific subject; and
select a second party comprises select a second party that is associated with communication on that subject.

20. The one or more non-transitory computer-readable media of claim 13, wherein:
initiate communication comprises initiating a video conferencing session; and
the instructions are further to cause the computing system to:
determine that quality for the video conferencing session has fallen below a pre-set threshold; and
transition communication to an audio channel.

21. An apparatus, comprising:
one or more computing processors; and
one or more modules configured to execute on the computing processors to:
receive a request for a communication between the first party and a second party, by a third party physically present with the first party, on a device controlled by the third party;
select, from among one or more second parties, a second party that is available for a communication;
receive, from the device, indications of regulatory compliance relating to potential communications between the first party and the second party; and
based on receipt of the indications of regulatory compliance from the device, initiate communication between the first party and the second party using the device.

22. The apparatus of claim 21, wherein select the second party comprises select a second party that is currently available for communication.

23. The apparatus of claim 21, wherein select the second party comprises apply one or more business rules to one or more of: an identity of the first party, an identity of the second party, one or more areas of expertise of the second party, a topic for the communication, or a geographical location of the first or second party.

24. The apparatus of claim 21, wherein select a second party comprises select a second party comprises not select the second party if the second party has communicated with the first party within a pre-set timeframe or has exceeded a pre-set number of communications with the first party.

25. The apparatus of claim 21, wherein:
initiate communication comprises initiating a video conferencing session; and
the one or more modules are further to execute to:
determine that quality for the video conferencing session has fallen below a pre-set threshold; and
transition communication to an audio channel.
